(19) United States
(12) Patent Application Publication
(10) Pub. No.: US 2014/0160798 A1
(43) Pub. Date: Jun. 12, 2014

(54) Voltage Converting Circuit of Active-Clamping Zero Voltage Switch

(71) Applicant: Chung-Shan Institute of Science and Technology, Longtan Township (TW)

(72) Inventors: Chih-Hsien Chung, Longtan Township (TW); Gwo-Huei You, Longtan Township (TW); Kun-Feng Chen, Longtan Township (TW); Kuo-Kuang Jen, Longtan Township (TW); Yu-Min Liao, Longtan Township (TW)

(73) Assignee: CHUNG-SHAN INSTITUTE OF SCIENCE AND TECHNOLOGY, Longtan Township (TW)

(21) Appl. No.: 13/710,452

(22) Filed: Dec. 10, 2012

(51) Int. Cl. H02M 3/24

(52) U.S. Cl. CPC H02M 3/24
USPC 363/15

(57) ABSTRACT

The present invention relates to a voltage converting circuit of active-clamping zero voltage switch, consisting of a transformed unit, a primary-side input unit, a second-side output unit, and a first switch, wherein the primary-side input unit has a clamping capacitor and a second switch, which are used for avoid from the production of spike voltage on the first switch when the first switch is turned off, so as to increase the voltage conversion efficiency of the voltage converting circuit.

### BACKGROUND OF THE INVENTION

1. Field of the Invention

The present invention relates to a voltage converting circuit, and more particularly to a voltage converting circuit of active-clamping zero voltage switch, which is capable of avoiding from the production of spike voltage and increasing the voltage conversion efficiency.

2. Description of the Prior Art

For electronic products advance, the requirements on power supplies are getting more and high, for example, high power density, high conversion efficiency, small size, and light weight. According to these requirements, an isolated inverse SEPIC converter having advantages of constant energy output and soft switch is developed and then widely applied in various electronic products and electrical equipments.

Please refer to FIG. 1, there is shown a circuit framework diagram of the conventional isolated inverse SEPIC converter. As shown in FIG. 1, the conventional isolated inverse SEPIC converter 10 consists of a transformer (1:n), a switch S₁, a capacitor C₁, an output diode D₁, an output inductor Lₒ, and an output capacitor Cₒ, wherein the transformer (1:n) has a leakage inductor Lᵣ and a magnetizing inductor Lₘ, and the switch S₁ includes a body diode and a parasitic capacitor Cᵣ.

In the conventional isolated inverse SEPIC converter 10, for the transformer (1:n) has the leakage inductor Lᵣ and the magnetizing inductor Lₘ and the switch S₁ includes the body diode and the parasitic capacitor Cᵣ, the switch S₁ must bears a very high spike voltage caused by a resonant loop made of the leakage inductor Lᵣ and the parasitic capacitor Cᵣ when the switch S₁ is turned off, and that would further results in large switching loss to the switch S₁. For above reasons, how to avoid from the production of spike voltage and switching loss is then becoming an important study issue.

Accordingly, in view of the conventional isolated inverse SEPIC converter still have shortcomings of the production of spike voltage and switching loss, the inventor of the present application has made great efforts to make inventive research thereon and eventually provided a voltage converting circuit of active-clamping zero voltage switch.

### SUMMARY OF THE INVENTION

The first objective of the present invention is to provide a voltage converting circuit of active-clamping zero voltage switch, which is capable of avoiding from the production of spike voltage and increasing the voltage conversion efficiency.

Accordingly, to achieve the primary objective of the present invention, the inventor of the present invention provides a voltage converting circuit of active-clamping zero voltage switch, comprising:
a transformer unit, being coupled to an input voltage and having a primary side coil and a secondary side coil;
a primary-side input unit, being coupled to the input voltage and parallel connected to the primary side coil of the transformer unit;
a second-side output unit, being parallel connected to the secondary side coil of the transformer unit; and
a first switch, being coupled to the primary side coil and a second switch of the primary-side input unit;
wherein the primary-side input unit further comprises a clamping capacitor coupled to the input voltage, and the second switch being coupled between the clamping capacitor and the primary side coil, so as to make the second switch able to be turned on and subsequently clamp the cross voltage on the first switch after the first switch is turned off.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 is a circuit framework diagram of a conventional isolated inverse SEPIC converter;

FIG. 2 is a circuit diagram of a voltage converting circuit of active-clamping zero voltage switch according to the present invention;

FIG. 3 is a controlling timing diagram of the voltage converting circuit of active-clamping zero voltage switch according to the present invention;

FIGS. 4A-4I are equivalent circuit diagrams showing the voltage converting circuit of active-clamping zero voltage switch according to the controlling timing diagram of FIG. 3.

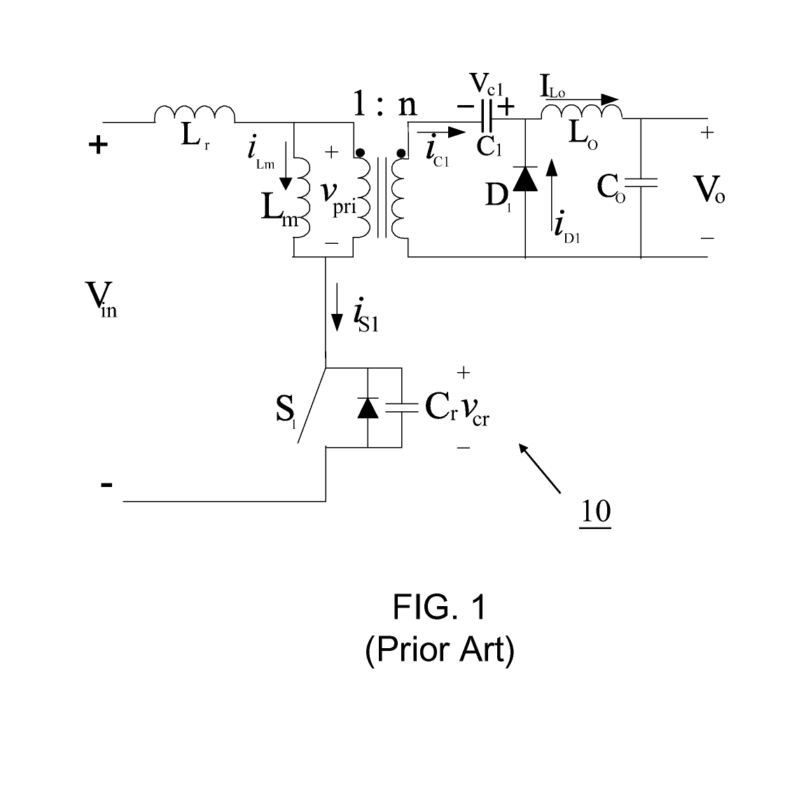

### DETAILED DESCRIPTION OF THE PREFERRED EMBODIMENTS

To more clearly describe a voltage converting circuit of active-clamping zero voltage switch according to the present invention, embodiments of the present invention will be described in detail with reference to the attached drawings hereinafter.

Active clamping technology is used for replacing a snubber diode by an active switch for transmitting the energy of spike voltage back to the input end of a circuit by way of resonance, so as to reduce power losses of the circuit.

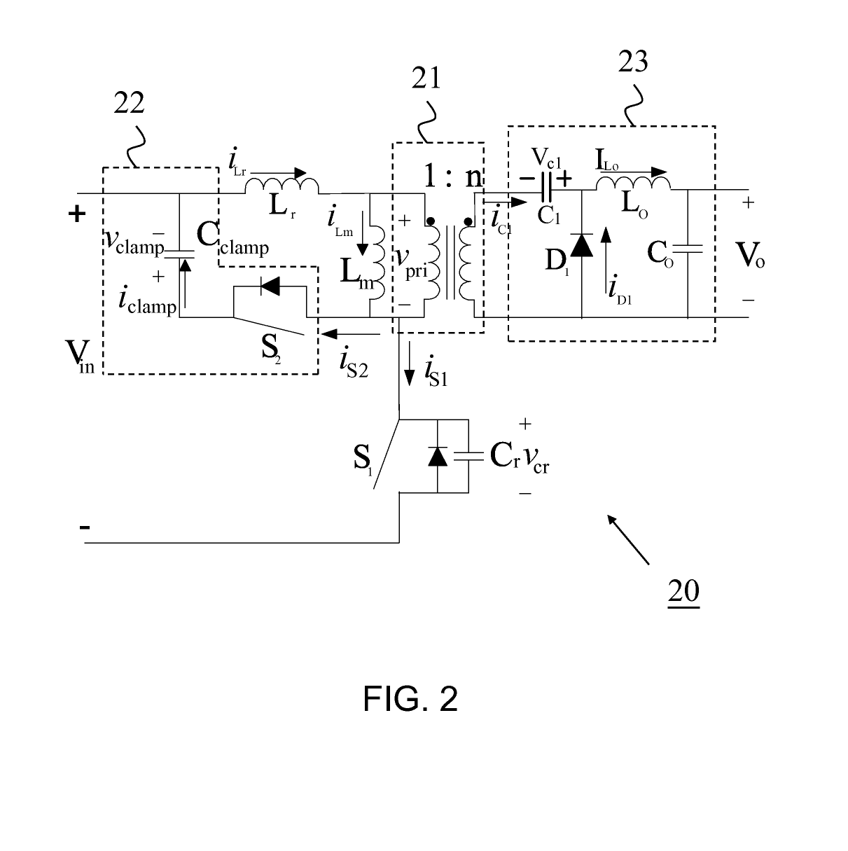

Please refer to FIG. 2, which illustrates a circuit diagram of a voltage converting circuit of active-clamping zero voltage switch according to the present invention. As shown in FIG. 2, the voltage converting circuit of active-clamping zero voltage switch of the present invention 20 consists of a transformer unit 21, a primary-side input unit 22, a second-side output unit 23, and a first switch S₁, wherein the transformer unit 21 is coupled to an input voltage Vᵢₙ and has a primary side coil and a secondary side coil.

The primary-side input unit 22 is coupled to the input voltage Vᵢₙ and parallel connected to the primary side coil of the transformer unit 21. In the present invention, the primary-side input unit 22 consists of a clamping capacitor C_{clamp} and a second switch S₂, wherein the clamping capacitor C_{clamp} is coupled to the input voltage Vᵢₙ, and the second switch S₂ is coupled between the clamping capacitor C_{clamp} and the primary side coil of the transformer unit 21. The second-side output unit 23 is parallel connected to the secondary side coil of the transformer unit 21, and consists of a capacitor C₁, a rectifier (output diode) D₁, an output inductor Lₒ, and an output capacitor Cₒ. In the second-side output unit 23, the capacitor C₁ is coupled to the secondary side coil of the transformer unit 21, the rectifier D₁ is coupled between the capacitor C₁ and a ground end, the output inductor Lₒ is coupled to the capacitor C₁ and the rectifier D₁, and output capacitor Cₒ is coupled between the output inductor Lₒ and the ground end. Therefore, the first switch S₁ is coupled to the primary side coil and the second switch S₂, such that the second switch S₂ can be turned on and subsequently clamp the cross voltage on the first switch S₁ after the first switch S₁ is turned off.

Before detailedly describing the circuit principle of the second switch S₂ being used for clamping the cross voltage on the first switch S₁, following hypotheses must be firstly defined:
(1) Both the first switch S1 and the second switch S2 have no forward voltage drop and leakage current;
(2) The circuit is operated in steady-state continuous current mode;
(3) The leakage inductor Lᵣ of the transformer unit 21 is hugely smaller than the magnetizing inductor Lₘ(Lᵣ<<Lₘ);
(4) The storage energy of resonant inductor (i.e., the output inductor Lₒ) is greater than the storage energy of resonant capacitor (i.e., the output capacitor Cₒ);
(5) The switch-on time for the first switch S1 and the second switch S2 is respectively DT and (1−D)T, and the dead time thereof is largely smaller then the switch-on time; and
(6) The output voltage is smaller than the input voltage.

When the first switch S₁ is turned on, the voltage crossed on the output inductor Lₒ is (V_{c1}+nVᵢₙ−Vₒ), and the voltage crossed on the output inductor Lₒ is −Vₒ when the second switch S₂ is turned on; So that, the following equation (3) can be derived according to voltage-second balance principle:

(V_{c1}+nVᵢₙ−Vₒ)=Vₒ(1−D) (3)

Similarly, because the magnetizing inductor Lₘ also needs to meet voltage-second balance principle, the following equation (4) can be derived:

DVᵢₙ=V_{clamp}(1−D) (4)

Moreover, because equation (5) of nV_{clamp=V}_{c1} is obtained when the out diode D₁ is turned on, the following equations (6), (7) and (8) can be further derived from the equations (3), (4) and (5):

V_{C1}=Vₒ (6)

V_{clamp}=(DVᵢₙ)/(1−D) (7)

Vₒ=(nDVᵢₙ)/(1−D) (8)

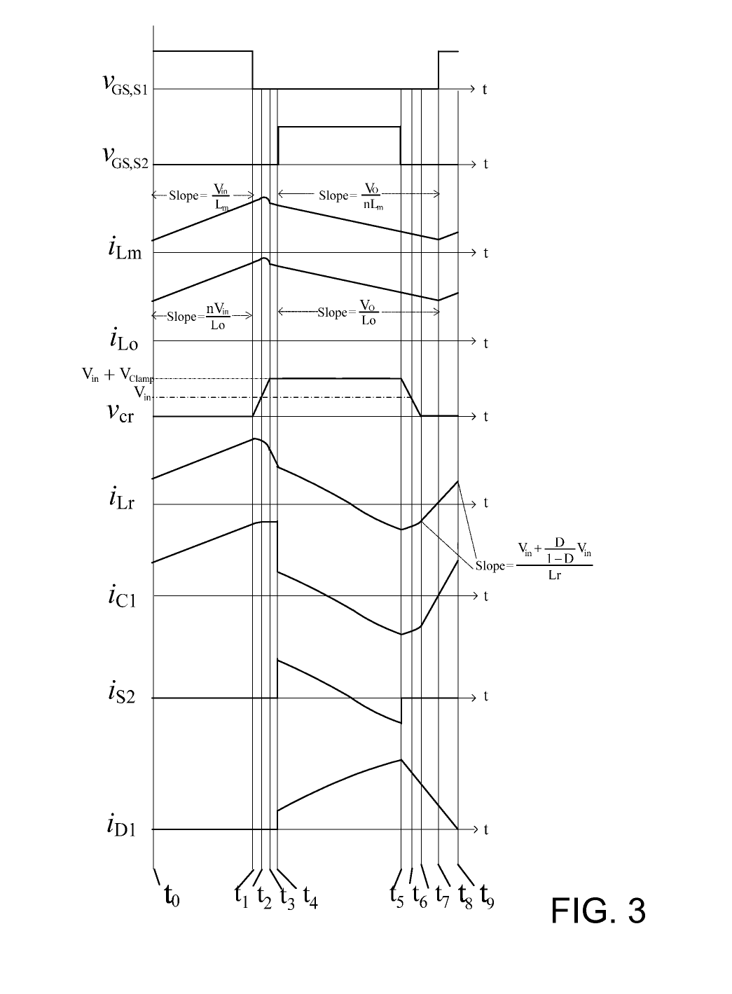

Please simultaneously refer to FIG. 3, there is shown a controlling timing diagram of the voltage converting circuit of active-clamping zero voltage switch according to the present invention. As shown in FIG. 3, the voltage converting circuit 20 includes 9 operation states:

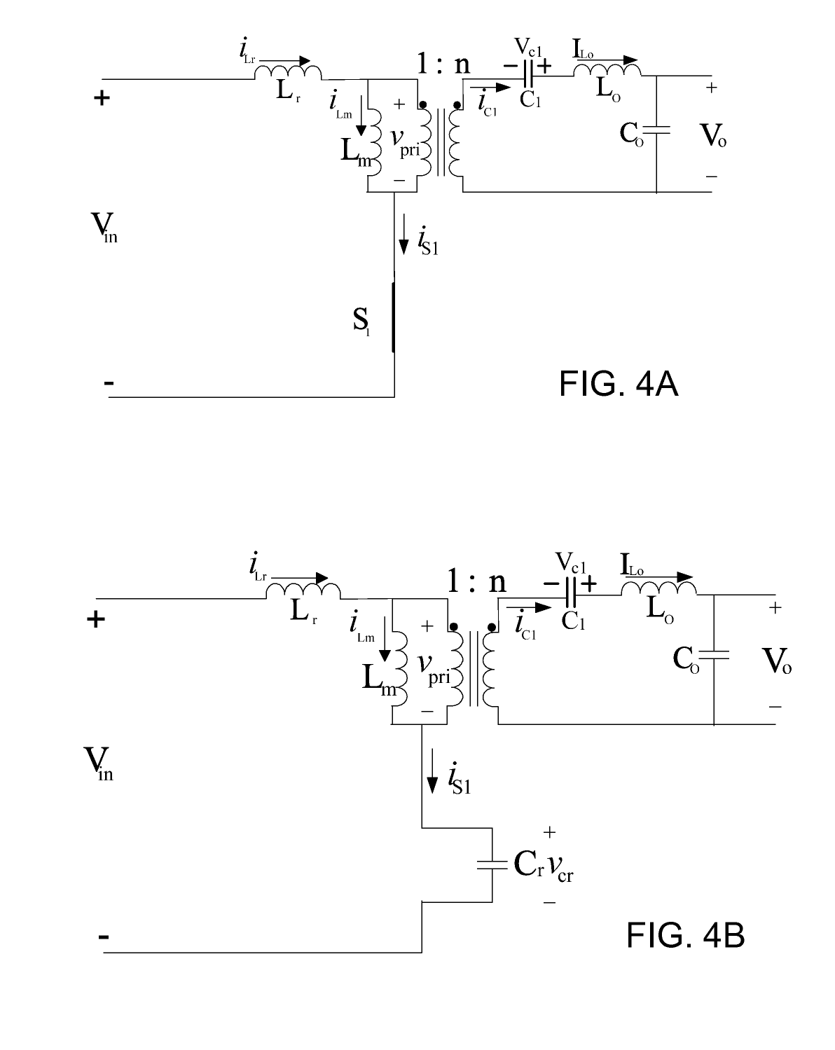

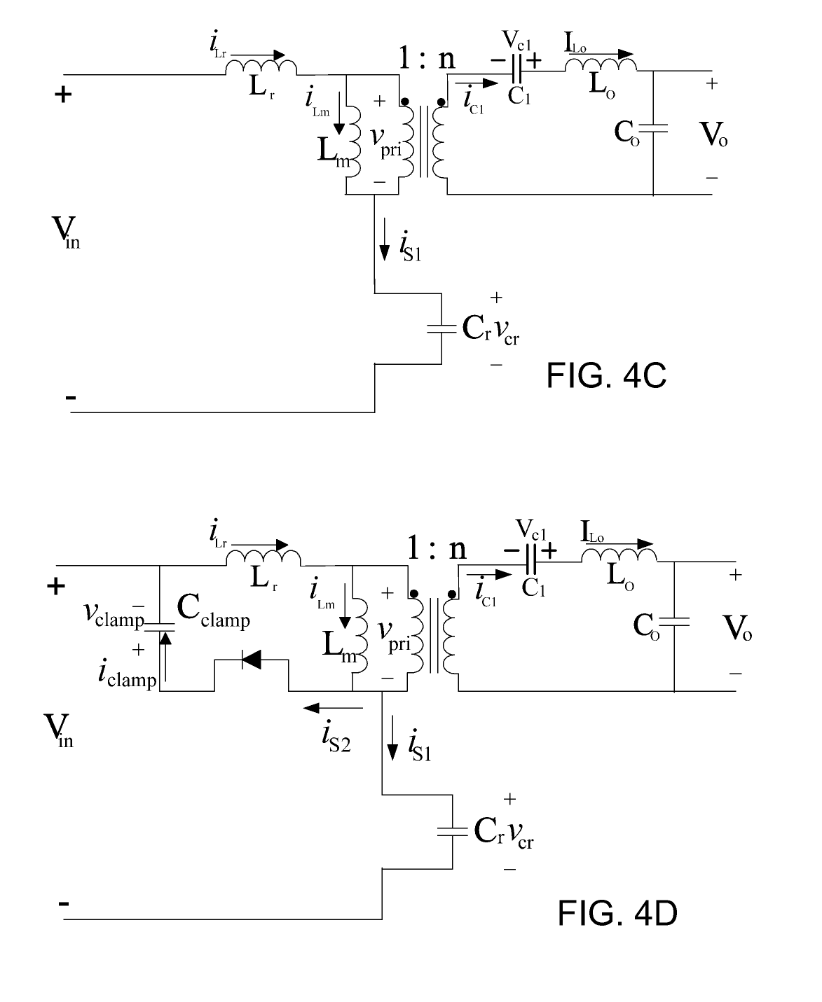

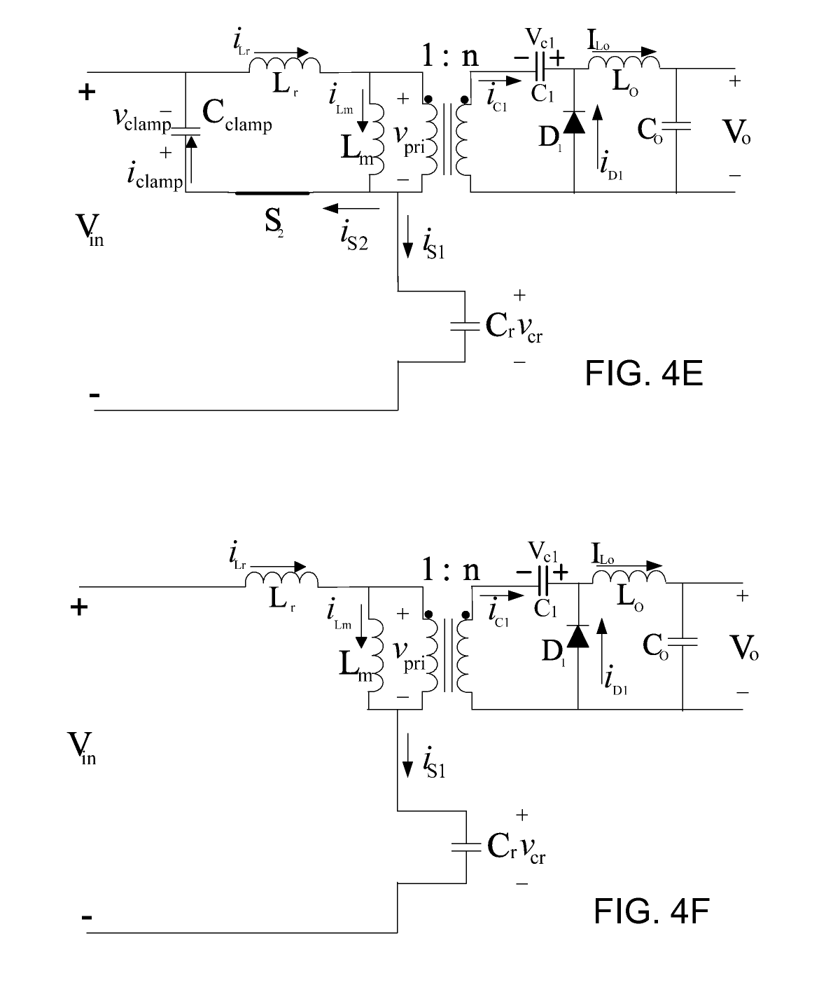

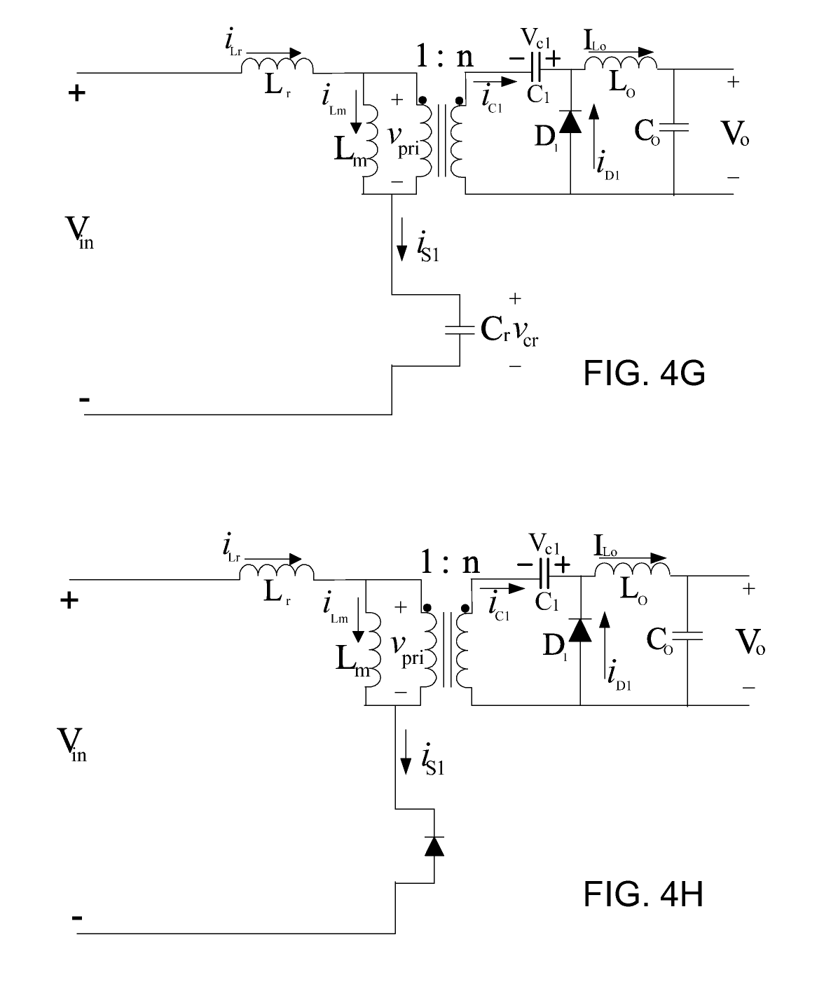

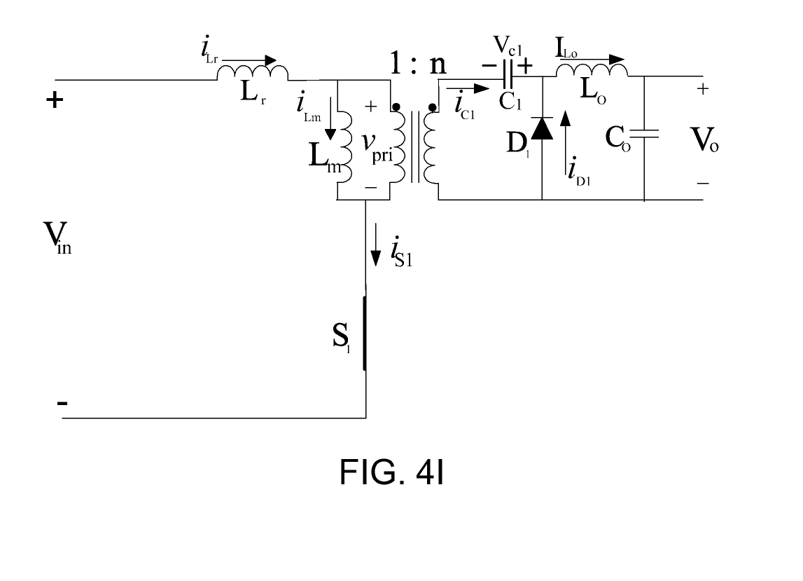

Firstly, the first operation state of the voltage converting circuit 20 actuates in time interval of t₀˜t₁. As an equivalent circuit diagram of the voltage converting circuit in time interval of t₀˜t₁ shown in FIG. 4A, because the first switch S1 is turned on at t₀, the primary side coil of the transformed unit 21 is parallel connected to the input voltage Vᵢₙ directly, such that the voltage νₚᵣᵢ of the primary side coil is equal to the input voltage Vᵢₙ; meanwhile, since the rectifier (output diode D₁) is turned off, the energy is transmitted from the primary side coil of the transformed unit 21 to the secondary side coil, so as to charge the output inductor Lₒ via the capacitor C₁. In this time interval, the resonant inductor current i_{Lr} can be calculated by following equations (9) and (10):

$$\begin{matrix}{i}_{Lr} ( t ) = \frac{{V}_{in}}{{L}_{r} + {L}_{m}} t - {i}_{Lm} ( {t}_{0} ) + \frac{{I}_{Lo}}{n} & ( 9 ) \\ {v}_{pri} ( t ) \approx {V}_{in} & ( 10 )\end{matrix}$$

Next, the second operation state of the voltage converting circuit 20 actuates in time interval of t₁˜t₂. As an equivalent circuit diagram of the voltage converting circuit in time interval of t₁˜t₂ shown in FIG. 4B, because the first switch S₁ is turned on and the second switch S₂ is waiting for being turned on at t₁, the parasitic capacitor Cᵣ is charged by the currents of ni_{C1} and i_{Lm} reflected from the secondary side coil of the transformed unit 21, such that the voltage ν_{cr} of the parasitic capacitor Cᵣ is increased and the voltage νₚᵣᵢ of the primary side coil is oppositely reduced. In addition, since the voltage νₚᵣᵢ of the primary side coil is still greater than zero, the energy is continuously transmitted from the primary side coil of the transformed unit 21 to the secondary side coil, so as to charge the output inductor Lₒ via the capacitor C₁. Furthermore, when the voltage ν_{cr} of the parasitic capacitor Cᵣ is charged to Vᵢₙ, the voltage νₚᵣᵢ of the primary side coil is oppositely reduced to zero. In this time interval, following equations (11)-(14) can be derived from leakage inductor current i_{Lr} and the parasitic capacitor voltage ν_{cr}:

$$\begin{matrix}{i}_{Lr} ( {t}_{2} ) ≅ {i}_{Lr} ( {t}_{1} ) = n \cdot {I}_{Lo} + {i}_{Lm} ( {t}_{1} ) & ( 11 ) \\ {v}_{Cr} ( t ) = \frac{{i}_{Lx} ( {t}_{1} )}{{C}_{r}} ( t - {t}_{1} ) & ( 12 ) \\ ( {t}_{2} - {t}_{1} ) = Δ {t}_{12} = \frac{{C}_{r} \times {V}_{in}}{{i}_{Lr} ( {t}_{1} )} & ( 13 ) \\ {v}_{pri} ( {t}_{2} ) = 0 & ( 14 )\end{matrix}$$

Furthermore, the third operation state of the voltage converting circuit 20 actuates in time interval of t₂˜t₃. As an equivalent circuit diagram of the voltage converting circuit in time interval of t₂˜t₃ shown in FIG. 4C, because the first switch S₁ is turned on and the second switch S₂ is waiting for being turned on at t₂, the voltage νₚᵣᵢ of the primary side coil is smaller than zero; besides, since the capacitor C₁ continuously charges the output inductor Lₒ, a resonant circuit is constituted by the equivalent resonant inductor Lᵣ+Lₘ and the parasitic capacitor Cᵣ, therefore the leakage inductor Lᵣ starts to charge the parasitic capacitor Cᵣ, and then the voltage ν_{cr} of the parasitic capacitor Cᵣ is increased and facilitate the body diode of the second switch S₂ be turned on. In this time interval, following equations (15)-(20) can be derived from leakage inductor current i_{Lr} and the parasitic capacitor voltage ν_{cr}:

$$\begin{matrix}{i}_{Lr} ( t ) = {i}_{Lr} ( {t}_{2} ) cos {ω}_{O} ( t - {t}_{2} ) & ( 15 ) \\ {v}_{cr} ( t ) = {i}_{Lr} ( {t}_{2} ) {Z}_{O} sin {ω}_{O} ( t - {t}_{2} ) + {V}_{in} & ( 16 ) \\ {Z}_{O} = \sqrt{\frac{{L}_{r} + {L}_{m}}{{C}_{r}}} & ( 17 ) \\ {ω}_{O} = \frac{1}{\sqrt{( {L}_{r} + {L}_{m} ) {C}_{r}}} & ( 18 ) \\ {i}_{Lr} ( {t}_{2} ) \approx {i}_{Lr} ( {t}_{1} ) = \frac{{I}_{Lo}}{n} + {i}_{Lm} ( {t}_{1} ) & ( 19 ) \\ {t}_{3} - {t}_{2} = Δ {t}_{23} = \frac{{sin}^{- 1} [ \frac{{V}_{Clamp}}{{i}_{Lr} ( {t}_{2} ) {Z}_{O}} ]}{{ω}_{O}} & ( 20 )\end{matrix}$$

The fourth operation state of the voltage converting circuit 20 actuates in time interval of t₃˜t₄. As an equivalent circuit diagram of the voltage converting circuit in time interval of t₃˜t₄ shown in FIG. 4D, because the first switch S₁ and the body diode of the second switch S₂ are turned on at t₃, the zero voltage switch of the second switch S₂ can be further carried out by way of turning the second switch S₂ on (wherein the second switch S₂ is turned on after the first switch S₁ is turned off for a first specific time (t₃−t₁)), such that the switch losses of the second switch S₂ are largely reduced. In addition, the leakage inductor current i_{Lr} would linearly reduce due to the voltage V_{clamp} of the clamping capacitor C_{clamp} is kept to a constant. In this time interval, the leakage inductor current i_{Lr} can be calculated by following equations (21)-(23):

$$\begin{matrix}{i}_{Lr} = - \frac{{V}_{Clamp}}{{L}_{r}} t = {i}_{Lr} ( {t}_{3} ) & ( 21 ) \\ {v}_{pri} ( t ) = 0 & ( 22 ) \\ {t}_{4} - {t}_{3} = Δ {t}_{34} = [ {i}_{Lr} ( {t}_{3} ) - {i}_{Lr} ( {t}_{4} ) ] \frac{{L}_{r}}{{V}_{Clamp}} & ( 23 )\end{matrix}$$

The fifth operation state of the voltage converting circuit 20 actuates in time interval of t₄˜t₅. As an equivalent circuit diagram of the voltage converting circuit in time interval of t₄˜t₅ shown in FIG. 4E, because the first switch S₁ and the second switch S₂ are turned on at t₄, the voltage νₚᵣᵢ of the primary side coil is approximated to the voltage V_{clamp} of the clamping capacitor C_{clamp}, and voltage νₚᵣᵢ is reflected to the secondary side coil of the transformer unit 21, so as to turn the rectifier (output diode D₁) on; meanwhile the magnetizing inductor Lₘ releases energy to charge the capacitor C₁, and the leakage inductor current i_{Lr} charges the clamping capacitor C_{clamp}. Furthermore, when the leakage inductor current i_{Lr} reduces to zero, the clamping capacitor C_{clamp} starts to release energy to the leakage inductor Lᵣ, such that the second switch S₂ is turned off. In this time interval, following equations (24)-(27) can be derived from leakage inductor current i_{Lr} and the parasitic capacitor voltage ν_{cr}:

$$\begin{matrix}{i}_{Lr} ( t ) = \frac{- {V}_{Clamp}}{{L}_{r} + {L}_{m}} t + {i}_{Lr} ( {t}_{4} ) & ( 24 ) \\ {v}_{pri ( t )} = \frac{- {L}_{m}}{{L}_{r} + {L}_{m}} {V}_{Clamp} \approx {V}_{Clamp} & ( 25 ) \\ {v}_{ct} ( t ) = {V}_{in} + {V}_{Clamp} & ( 26 ) \\ {i}_{Lr} ( {t}_{5} ) ≅ {i}_{Lm} ( {t}_{5} ) & ( 27 )\end{matrix}$$

The sixth operation state of the voltage converting circuit 20 actuates in time interval of t₅˜t₆. As an equivalent circuit diagram of the voltage converting circuit in time interval of t₅˜t₆ shown in FIG. 4F, because the first switch S₁ and the second switch S₂ are turned off at t₅, a resonant circuit is constituted by the leakage inductor Lᵣ and the parasitic capacitor Cᵣ of the first switch S₁; meanwhile the voltage ν_{cr} of the parasitic capacitor Cᵣ reduces to Vᵢₙ. In this time interval, following equations (28)-(32) can be derived from leakage inductor current i_{Lr} and the parasitic capacitor voltage ν_{cr}:

$$\begin{matrix}{i}_{Lr} ( t ) = {i}_{Lr} ( {t}_{5} ) cos {ω}_{1} ( t - {t}_{5} ) & ( 28 ) \\ {v}_{cr} ( t ) = {i}_{Lr} ( {t}_{5} ) {Z}_{1} sin {ω}_{1} ( t - {t}_{5} ) + \frac{{V}_{in}}{1 - D} & ( 29 ) \\ {Z}_{1} = \sqrt{\frac{{L}_{r}}{{C}_{r}}} & ( 30 ) \\ {ω}_{1} = \frac{1}{\sqrt{{L}_{r} \cdot {C}_{r}}} & ( 31 ) \\ {t}_{6} - {t}_{5} = Δ {t}_{56} = {sin}^{- 1} \frac{- {V}_{Clamp}}{{i}_{Lr} ( {t}_{5} ) {Z}_{1} {ω}_{1}} & ( 32 )\end{matrix}$$

The seventh operation state of the voltage converting circuit 20 actuates in time interval of t₆˜t₇. As an equivalent circuit diagram of the voltage converting circuit in time interval of t₆˜t₇ shown in FIG. 4G, because the first switch S₁ and the second switch S₂ are turned off at t₆, the resonant circuit is continuously formed by the leakage inductor Lᵣ and the parasitic capacitor Cᵣ of the first switch S₁ until the voltage ν_{cr} of the parasitic capacitor Cᵣ reduces to zero. In this time interval, following equations (33)-(37) can be derived from leakage inductor current i_{Lr} and the parasitic capacitor voltage ν_{cr}:

$$\begin{matrix}{i}_{Lr} ( t ) = \frac{{V}_{Clamp}}{{Z}_{O}} sin {ω}_{1} ( t - {t}_{6} ) + {i}_{Lr} ( {t}_{6} ) cos {ω}_{1} ( t - {t}_{6} ) & ( 33 ) \\ {v}_{cr} ( t ) = - {V}_{Clamp} cos {ω}_{1} ( t - {t}_{6} ) + {i}_{Lr} ( {t}_{6} ) {Z}_{1} sin {ω}_{1} ( t - {t}_{6} ) + \frac{{V}_{in}}{1 - D} & ( 34 ) \\ {v}_{cr} ( {t}_{7} ) = 0 & ( 35 ) \\ {W}_{Lr} = \frac{1}{2} {L}_{r} {i}_{Lr}^{2} ( {t}_{6} ) & ( 36 ) \\ {W}_{Cr} = \frac{1}{2} {C}_{r} {V}_{in}^{2} & ( 37 )\end{matrix}$$

Moreover, for carrying out the zero voltage switch of the first switch S₁, the energy storage of the leakage inductor Lᵣ must meets the following equation (38):

Lᵣi_{Lr}²(t₆)>CᵣVᵢₙ² (38)

Next, the eighth operation state of the voltage converting circuit 20 actuates in time interval of t₇˜t₈. As an equivalent circuit diagram of the voltage converting circuit in time interval of t₇˜t₈ shown in FIG. 4H, because the second switch S₂ is turned off at t₇ and the voltage ν_{cr} of the parasitic capacitor Cᵣ is zero, the zero voltage switch of the first switch S₁ can be carried out after the body diode of the first switch S₁ is turned on and the first switch S₁ is subsequently turned on, wherein the first switch is S₁ turned on after the second switch S₂ is turned off for a second specific time (t₇−t₅). In this time interval, the leakage inductor current i_{Lr} can be calculated by following equation (39):

$${i}_{Lr} ( t ) = \frac{{V}_{in} + \frac{{DV}_{in}}{1 - D}}{{L}_{r}} t + {i}_{Lr} ( {t}_{7} ) \qquad ( 39 )$$

Eventually, the ninth operation state of the voltage converting circuit 20 actuates in time interval of t₈˜t₉. As an equivalent circuit diagram of the voltage converting circuit in time interval of t₈˜t₉ shown in FIG. 4I, because the first switch S₁ and the rectifier (output diode D₁) are turned off at t₈, the capacitor C₁ is still being charged and the voltage crossed on the leakage inductor Lᵣ is equal to Vᵢₙ+(DVᵢₙ)/(1−D), therefore the leakage inductor i_{Lr} still can be calculated by above equation (39).

Thus, through the descriptions, the circuit framework, circuit components and performances of the voltage converting circuit of active-clamping zero voltage switch have been completely introduced and disclosed; in summary, this voltage converting circuit of active-clamping zero voltage switch proposed by the present invention can solve the problem of the production of spike voltage occurred in the conventional isolated inverse SEPIC converter, moreover, the voltage converting circuit of active-clamping zero voltage switch can further reuse the spike voltage on the power switch (i.e. the first switch S₁) for carrying out the zero voltage switch of the power switch.

The above description is made on embodiments of the present invention. However, the embodiments are not intended to limit scope of the present invention, and all equivalent implementations or alterations within the spirit of the present invention still fall within the scope of the present invention.

What is claimed is:

1. A voltage converting circuit of active-clamping zero voltage switch, comprising:
a transformer unit, being coupled to an input voltage and having a primary side coil and a secondary side coil;
a primary-side input unit, being coupled to the input voltage and parallel connected to the primary side coil of the transformer unit;
a second-side output unit, being parallel connected to the secondary side coil of the transformer unit; and
a first switch, being coupled to the primary side coil and a second switch of the primary-side input unit;
wherein the primary-side input unit further comprises a clamping capacitor coupled to the input voltage, and the second switch being coupled between the clamping capacitor and the primary side coil, so as to make the second switch able to be turned on and subsequently clamp the cross voltage on the first switch after the first switch is turned off.

2. The voltage converting circuit of active-clamping zero voltage switch of claim 1, wherein the second switch is turned on after the first switch is turned off for a first specific time.

3. The voltage converting circuit of active-clamping zero voltage switch of claim 1, wherein the second-side output unit comprises:
a capacitor, being coupled to the secondary side coil of the transformer unit;
a rectifier, being coupled between the capacitor and a ground end;
an output inductor, being coupled to the capacitor and the rectifier; and
an output capacitor, being coupled between the output inductor and the ground end.

4. The voltage converting circuit of active-clamping zero voltage switch of claim 3, wherein the rectifier is a diode.

5. The voltage converting circuit of active-clamping zero voltage switch of claim 1, wherein the voltage crossing on the primary side coil of the transformer unit is the same to the voltage crossing on the clamping capacitor.

6. The voltage converting circuit of active-clamping zero voltage switch of claim 2, wherein the second switch is then turned off after the voltage crossing on the clamping capacitor is reduced.

7. The voltage converting circuit of active-clamping zero voltage switch of claim 6, wherein the first switch is turned on after the second switch is turned off for a second specific time.
